(19) United States
(12) Patent Application Publication
(10) Pub. No.: US 2011/0210913 A1
(43) Pub. Date: Sep. 1, 2011

(54) DISPLAY AND WRITING DEVICE

(75) Inventors: HSIAO-KUANG HU, TAIPEI COUNTY (TW); KWEI-LAN LEE, TAIPEI COUNTY (TW); LI-HSIN LIU, TAIPEI COUNTY (TW); CHUN-HSIU CHAN, TAIPEI COUNTY (TW); SHANG-TSANG HSUEH, TAIPEI COUNTY (TW)

(73) Assignees: INVENTEC APPLIANCES (SHANGHAI) CO. LTD., Shanghai (CN); INVENTEC APPLIANCES CORP., TAIPEI COUNTY (TW)

(21) Appl. No.: 13/035,169

(22) Filed: Feb. 25, 2011

(30) Foreign Application Priority Data
Mar. 1, 2010 (CN) 201010115430.X

(51) Int. Cl. G09G 5/00

(52) U.S. Cl. 345/156

(57) ABSTRACT

A display and writing device is disclosed that comprises a flexible interface module for providing a writing surface and displaying a captured content; a scanner for scanning the writing surface and producing the captured content accordingly; at least two rollers for driving the flexible interface module to pass the scanner; and an operating module used to operate the flexible interface module, the scanner and the rollers.

### BACKGROUND OF THE INVENTION

1. Field of the Invention

The present invention relates to a display and writing device, and more particularly to a display and writing device capable of performing information processing in a two-way manner.

2. Description of Related Art

A white board is an erasable white writing platform made of a plastic material and used for repeatedly writing on a writing surface of the white board by a specified white board pen, but the conventional white board still has general problems of a traditional technology. The information written on the white board is provided for viewing at the spot only. If it will be shared with others at different locations, the content must be copied or drawn manually for its duplication, thereby resulting that there may be a difference between the copied content and the original data or a missing part of the details of the original information. Thus, it is very difficult for users to review the drawings, tables or charts drawn on the white board.

In view of the aforementioned problem, some manufacturers developed an electronic white board capable of recording, duplicating and digitizing the contents written on the electronic white board to overcome the aforementioned problem. The electronic white board can provide a paperless working and/or teaching environment by applying the principle of electromagnetic induction operated together with a computer and an overhead projector.

The electronic white board is divided according to its operating principle into two types, respectively: a pressure-sensitive white board and a laser tracking white board. A touch white board adopting the pressure-sensitive principle is analogous to a touch screen of a computer and is used as a man-machine interactive input device in which users touch an option displayed on the screen by a finger or a pen to complete a task. There are two layers of pressure-sensitive films in the electronic white board. If a pressure is exerted onto a certain point of the surface of the white board, the two films at the touching point creates a short circuit, and a controller of the electronic white board detects the coordinates (or the position where the finger or pen is touched) of the touching point and transmits the coordinates information to a computer through a RS232 interface. The white board adopting the laser tracking principle includes a laser transmitter installed separately on both sides of an upper end of the white board. After the white board is turned on, the laser transmitter emits a laser beam to scan the surface of the white board, and the specified pen has the function of sensing the laser beam to feed back the position of the pen.

In the development history of the white board, the earliest electronic white board is a duplicative electronic white board. As the technology advances, and the market requires more functions, an interactive electronic white board was introduced. Now, the both types of the electronic white boards are available in the market, and these two types of electronic white boards are described as follows.

The interactive electronic white board can have information communications with a computer. The electronic white board is connected to a PC, and an overhead projector is used for projecting the content shown on the PC to the screen of the electronic white board. A large screen can be formed with the support of a specific application program and used for a collaborative conference or a teaching environment. The specified setting pen is used for replacing a mouse in the operation of the white board, thus capable of performing any application program and any operation which can be implemented by the keyboard and the mouse of a computer, such as editing, interpreting and storing a file. The electronic white board and the PC are connected together such that the electronic white board serves as a handwriting tablet with a relatively large area. The electronic white board is provided for users to write and draw on the board freely, as well as displaying the written content on the PC instantly, and the file is saved as a graphic file, so that the interactive electronic white board is considered as a computer peripheral.

The duplicative electronic white board is a device capable of scanning and printing a content written on the white board by means of a simple operation performed by a user. The process of completing the foregoing function is the same as a general duplication process. Firstly, a graphic sensor collects the content written on the white board, and a signal is processed in an image processing process, and the image is outputted by a thermal printer, an ink-jet printer, a laser printer or any other printing method.

In addition, the interactive electronic white board can work together with a computer to achieve a two-way input/output function. However, the level of complexity for the installation, maintenance, and application are relatively high. Although the duplicative electronic white board provides the basic functions only, yet it comes with the advantages of a simple structure, a low cost, a convenient application, and a feature of satisfying the basic user requirements, so that the duplicative electronic white board is used extensively in offices. Present existing devices allow the information written on the white board to be transmitted in an electronic form or a paper form in a one-way manner, but images on the white board cannot be displayed by the electronic white board in a two-way manner.

### SUMMARY OF THE INVENTION

Therefore, an object of the present invention is to provide a display and writing device capable of performing information processing in a two-way manner for solving the problems in the art.

In an aspect, the present invention provides a display and writing device including a flexible interface module, a scanner, at least two rollers and an operating module. The flexible interface module is used for providing a writing surface and displaying a captured content. The scanner is used for scanning the writing surface and producing the captured content accordingly. The rollers are used for driving the flexible interface module to pass the scanner. And the operating module is electrically coupled to the flexible interface module, the scanner and the rollers, and is used to operate the flexible interface module, the scanner and the rollers. In the display and writing device, the scanner may be a fixed scanner.

The display and writing device may further comprise a storage module electrically coupled to the flexible interface module and the scanner for storing the captured content, which the flexible interface module can access through the storage module. A possibility in this case is that the display and writing device further comprises a transmission module electrically coupled to the storage module and capable of connecting to an accessing device for transmitting the captured content from the storage module to the accessing device. Another possibility in this case is that the display and writing device further comprises a wireless transmission module electrically coupled to the storage module for transmitting the captured content from the storage module to an accessing device.

In another aspect, the present invention provides a display and writing device comprising a flexible interface module, a scanner and an operating module. The flexible interface module is used for providing a writing surface and displaying a captured content. The scanner is capable of reciprocating in a line of scanning over the flexible interface module for scanning the writing surface and producing the captured content accordingly. And the operating module is electrically coupled to the flexible interface module and the scanner, and is used to operate the flexible interface module and the scanner.

The display and writing device may further comprise a storage module electrically coupled to the flexible interface module and the scanner for storing the captured content, which the flexible interface module can access through the storage module. A possibility in this case is that the display and writing device further comprises a transmission module electrically coupled to the storage module and capable of connecting to an accessing device for transmitting the captured content from the storage module to the accessing device. Another possibility in this case is that the display and writing device further comprises a wireless transmission module electrically coupled to the storage module for transmitting the captured content from the storage module to an accessing device.

The advantages and spirit of the present invention can be further understood by referring to the following detailed description of embodiments of the invention and the accompanying drawings.

### BRIEF DESCRIPTION OF THE DRAWINGS

FIG. 1 shows a functional block diagram of a display and writing device in accordance with an embodiment of the present invention;

FIG. 2 shows a schematic diagram of a display and writing device in accordance with an embodiment of the present invention;

FIG. 3 shows a schematic diagram of a display and writing device in accordance with another embodiment of the present invention;

FIG. 4 shows a schematic diagram of a display and writing device in accordance with another embodiment of the present invention; and

FIG. 5 shows a schematic diagram of a display and writing device in accordance with another embodiment of the present invention.

### DETAILED DESCRIPTION OF THE PREFERRED EMBODIMENTS

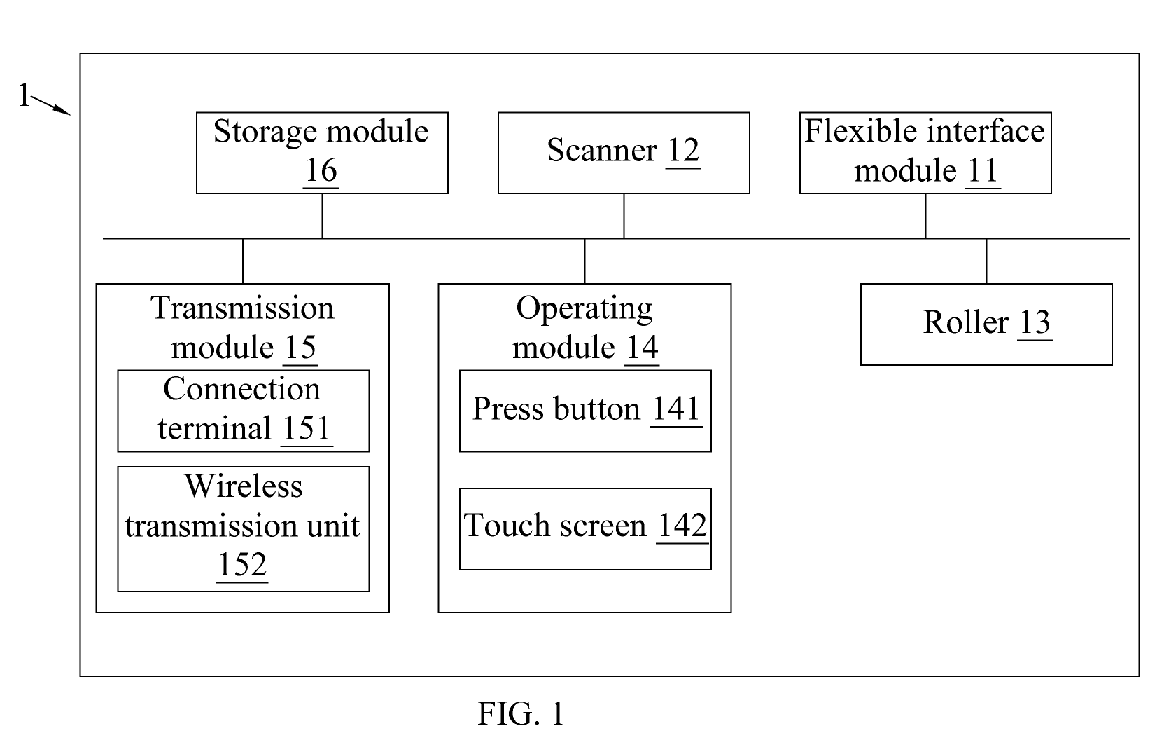

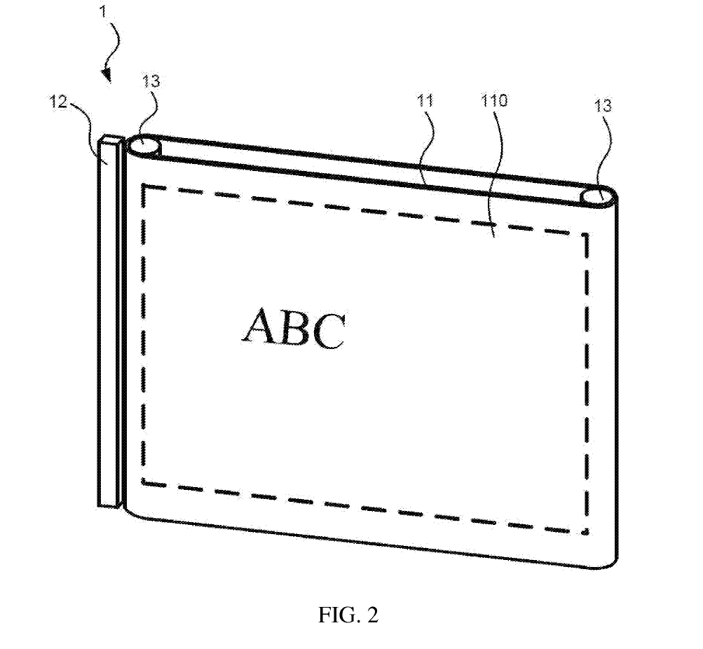

Please refer to FIGS. 1 and 2 respectively. FIG. 1 shows a functional block diagram of a display and writing device in accordance with an embodiment of the present invention; FIG. 2 shows a schematic diagram of a display and writing device in accordance with an embodiment of the present invention. As shown in FIG. 1, the display and writing device 1 according to an embodiment of the present invention comprises a flexible interface module 11, a scanner 12, at least two rollers 13, and an operating module 14. In certain embodiments, the display and writing device may further comprise a storage module 16, and may additionally comprise a transmission module 15 coupled to the storage module 16.

The flexible interface module 11 is used for providing a writing surface and displaying a captured content. For example, the flexible interface module 11 can provide or include a writing surface 110 on which a user can write or draw by using a finger or a pen, and also can display a captured content. The flexible interface module 11 may be a flexible display which may be an organic light emitting diode display, a cholesteric liquid crystal display, or an electrophoretic display. According to different types of the flexible display, the flexible properties of the flexible display can be different between the different types. The flexible display can display the captured content to a user. The surface of the display can be repeatedly written by a user using a writing tool which may be, but not limited to, a white board pen. If needed, the writing trace can be erased. There are differences between displayed colors according to different displays. For example, the organic light emitting diode display can output a color signal, but the single electrophoretic display can only support the output of grayscale images with a relatively lower cost.

The scanner 12 is used for scanning the writing surface or images such as characters, graphics and patterns on the writing surface of the flexible interface module 11, and for producing the captured content accordingly after processing by a processor. The scanner 12 may be a mobile scanner or a fixed scanner, or may be a scanning part. Of course in certain embodiments, the scanner 12 may scan the writing surface and then produce the captured content accordingly.

As shown in FIG. 2, the scanner 12 in this embodiment is a fixed scanner arranged on one side of the flexible interface module 11. By rolling the flexible interface module 11, the surface thereof can be scanned to thus obtain the captured content. When the storage module 16 is present, it may be electrically coupled to the flexible interface module 11 and the scanner 12 for storing the captured content, which captured content the flexible interface module 11 is able to access through the storage module 16. The captured content also may be transmitted through the transmission module 15 if present.

Each of the rollers 13 is for driving the flexible interface module 11 to pass the scanner. In this invention, the roller 13 may drive the flexible interface module to pass the scanner. In this embodiment, the roller 13 engages with an inner surface of the flexible interface module 11 for fixing their relative positions. The roller 13 may be of a rolling part, and can roll the flexible interface module 11 as horizontally and circularly such that the flexible interface module 11 can pass the scanner 12.

The operating module 14 is electrically coupled to the flexible interface module 11, the scanner 12 and the rollers 13, and is used to operate the flexible interface module 11, the scanner 12 and the rollers 13. The operating module 14 may comprise operating units, such as a press button 141 and a touch screen 142, and be used to control the display and writing device 1. For example, through the operating module 14 a user can control the rollers 13 to roll, or control the scanner 12 to scan. In addition, the touch screen 14 can further display messages comprising various transmission states or parameters of the display and writing device 1, and enable the user to more conveniently operate the display and writing device 1.

When the transmission module 15 is present, it may be coupled to the storage module 16 and capable of connecting to an accessing device for transmitting the captured content from the storage module 16 to the accessing device. The transmission module 15 or the display and writing device 1 may further comprise a connection terminal 151 and a wireless transmission module 152. The connection terminal 151, such as a USB connection terminal or an IEEE 1394 connection terminal, can be coupled to the accessing device by a wire transmission, and the wireless transmission module 152 can be coupled to the accessing device by a wireless transmission. The accessing device may be an external accessing device or one of other devices such as a flash disk, MP3 walkman, printer, mobile phone, e-book reader and notebook.

Again in this embodiment, the storage module 16 is electrically coupled to the flexible interface module 11 and the scanner 12 for storing the captured content from the flexible interface module 11 or the scanner 12. Besides, the flexible interface module 11 can access the captured content through the storage module 16. In practical applications, the storage module 16 may comprise a hard disk, flash memory, or one of other kinds of card-shaped storage media such as an SD card and an XD card.

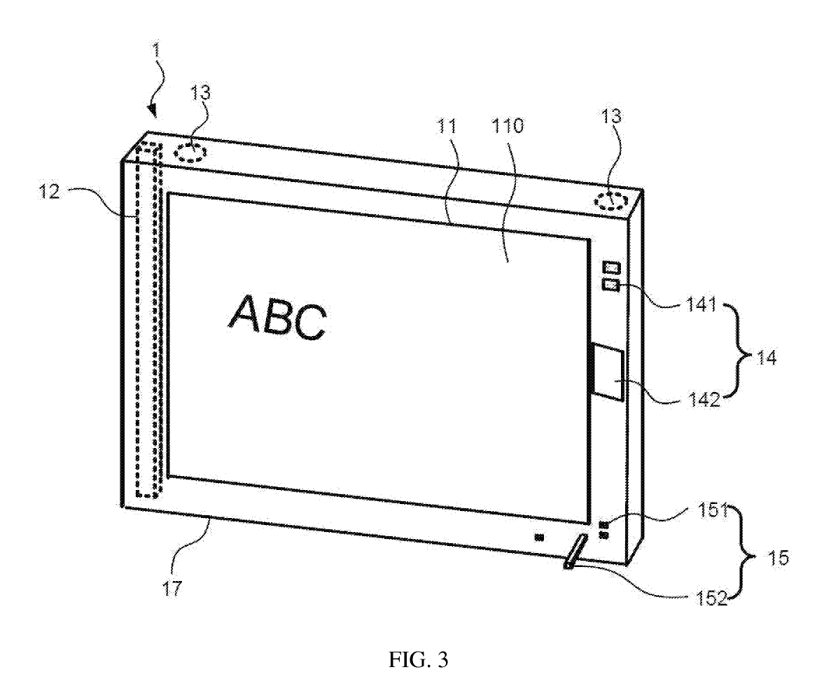

Please refer to FIG. 3. FIG. 3 shows a schematic diagram of a display and writing device in accordance with another embodiment of the present invention. A difference between the display and writing devices in FIGS. 2 and 3 is that the display and writing device in this embodiment further comprises a frame 17. As shown in FIG. 3, the press button 141 and touch screen 142 are included in the operating module 14, the connection terminal 151 and the wireless transmission module 152 are included in the transmission module 15, and the rollers 13 and the scanner 12 all can be disposed on the frame.

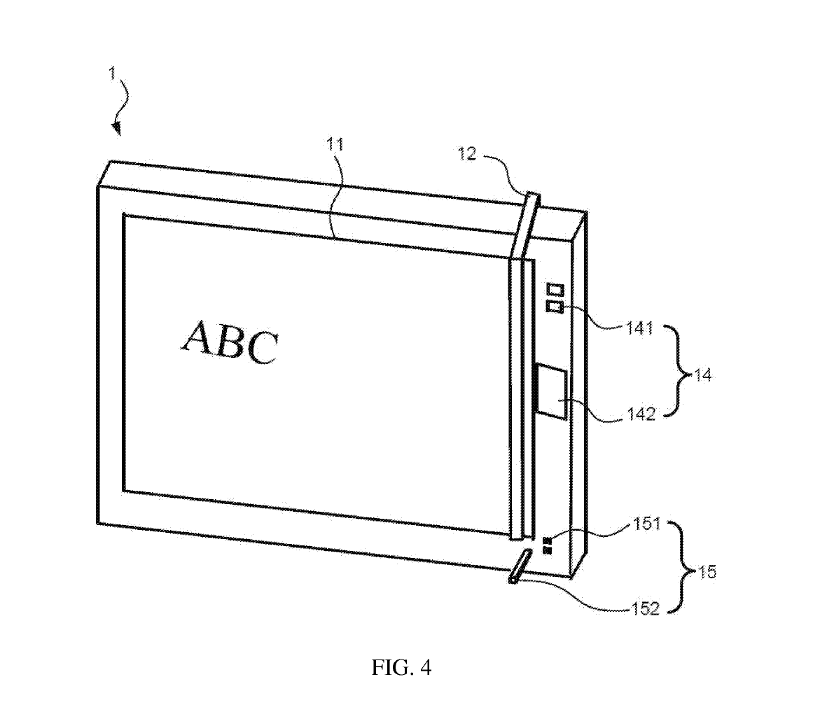

Please refer to FIG. 4. FIG. 4 shows a schematic diagram of a display and writing device in accordance with another embodiment of the present invention. As shown in FIG. 4, the display and writing device in this embodiment similarly comprises the flexible interface module 11, the scanner 12 and the operating module 14. A difference in the embodiment is that the display and writing device in this embodiment does not comprise the roller 13.

In addition, in this embodiment, the flexible interface module 11 may be a hard flat panel display which may be a liquid crystal display or a plasma display. According to the different types of displays, the thickness and weight of the display can be different between the different types. The surface of the hard flat panel display can be rewritable to or repeatedly written by a user using a writing tool which may be, but not limited to, a white board pen. If needed, the writing trace can be erased. Furthermore, the hard flat panel display can display the captured content to the user.

Moreover, in this embodiment, the scanner 12 may be a mobile scanner, which may be hung on the flexible interface module 11 and capable of reciprocating in a line of scanning over the flexible interface module 11 for scanning the writing surface 110 and producing the captured content, accordingly. Of course the scanner 12 may scan the writing surface 110 and then produce the captured content accordingly. When the storage module 16 is present, it may be electrically coupled to the flexible interface module 11 and the scanner 12 for storing the captured content, which captured content the flexible interface module 11 is able to access through the storage module 16. The captured content also may be transmitted through the transmission module 15 if present. By adopting the hard flat panel display and the mobile scanner, there is no need for the rollers 13 used to roll, thereby having a positive effect of extending the life of each element due to the reduction of movable elements.

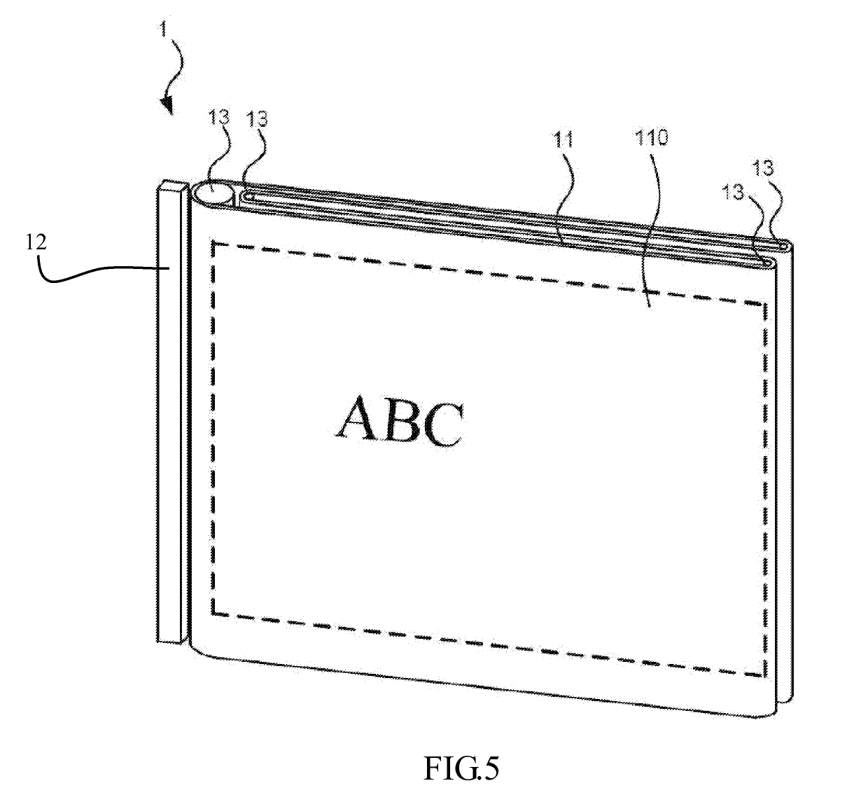

Please refer to FIG. 5. FIG. 5 shows a schematic diagram of a display and writing device in accordance with another embodiment of the present invention. As shown in FIG. 5, there are four rollers 13 in this embodiment. As shown in FIG. 5, when the number of rollers, which may comprise a rolling module, is increased from e.g. two to four, the writing surface 110 of the flexible interface module 11 may be disposed into substantially four writing surfaces or pages, thus decreasing the frequency of erasing the writing trace by the user.

In brief, in addition to having the function of being rewritable, the display and writing device of the present invention is able to scan and store characters, graphics, and so on, which are written or drawn by the user. The content stored previously can be displayed if needed later. Therefore, compared to the electronic white board in the prior art, the present invention should have an inventive step.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A display and writing device, comprising:
a flexible interface module, for providing a writing surface and displaying a captured content;
a scanner, for scanning the writing surface and producing the captured content accordingly;
at least two rollers, for driving the flexible interface module to pass the scanner; and
an operating module, electrically coupled to the flexible interface module, the scanner and the rollers, and used to operate the flexible interface module, the scanner and the rollers.

2. The display and writing device of claim 1, further comprising a storage module electrically coupled to the flexible interface module and the scanner for storing the captured content, which captured content the flexible interface module is able to access through the storage module.

3. The display and writing device of claim 2, further comprising a transmission module electrically coupled to the storage module and capable of connecting to an accessing device for transmitting the captured content from the storage module to the accessing device.

4. The display and writing device of claim 2, further comprising a wireless transmission module electrically coupled to the storage module for transmitting the captured content from the storage module to an accessing device.

5. The display and writing device of claim 1, wherein the scanner is a fixed scanner.

6. A display and writing device, comprising:
a flexible interface module, for providing a writing surface and displaying a captured content;
a scanner, capable of reciprocating in a line of scanning over the flexible interface module for scanning the writing surface and producing the captured content accordingly; and
an operating module, electrically coupled to the flexible interface module and the scanner and used to operate the flexible interface module and the scanner.

7. The display and writing device of claim 6, further comprising a storage module electrically coupled to the flexible interface module and the scanner for storing the captured content, which captured content the flexible interface module is able to access through the storage module.

8. The display and writing device of claim 7, further comprising a transmission module electrically coupled to the storage module and capable of connecting to an accessing device for transmitting the captured content from the storage module to the accessing device.

9. The display and writing device of claim 7, further comprising a wireless transmission module electrically coupled to the storage module for transmitting the captured content from the storage module to an accessing device.
